(19) United States
(12) Patent Application Publication
(10) Pub. No.: US 2024/0022122 A1
(43) Pub. Date: Jan. 18, 2024

(54) Electric Machine and Installation

(71) Applicant: Siemens Aktiengesellschaft, München (DE)

(72) Inventors: Carsten Schuh, Baldham (DE); Thomas Soller, Deggendorf, Bayern (DE); Rolf Vollmer, Gersfeld (DE)

(73) Assignee: Siemens Aktiengesellschaft, München (DE)

(21) Appl. No.: 18/247,110

(22) PCT Filed: Sep. 29, 2021
(86) PCT No.: PCT/EP2021/076722

§ 371 Date: Mar. 29, 2023

(30) Foreign Application Priority Data
Sep. 30, 2020 (EP) 20199234.4

(51) Int. Cl. H02K 1/04; H02K 1/12

(52) U.S. Cl. CPC H02K 1/04; H02K 1/12

(57) ABSTRACT

Various embodiments of the teachings herein include an electric machine. The electric machine may comprise a stator and/or a rotor with a stack of soft-magnetic laminations. Each lamination is close to an adjacent lamination on respective flat sides of the laminations. The laminations are electrically insulated from one another by a metal oxide formed on at least one of the flat sides.

### CROSS-REFERENCE TO RELATED APPLICATIONS

This application is a U.S. National Stage Application of International Application No. PCT/EP2021/076722 filed Sep. 29, 2021, which designates the United States of America, and claims priority to EP Application No. 20199234.4 filed Sep. 30, 2020, the contents of which are hereby incorporated by reference in their entirety.

### TECHNICAL FIELD

The present disclosure relates to electric machine. Various embodiments of the teachings herein include electric machines with a rotor and/or stator, having a stack of soft-magnetic laminations.

### BACKGROUND

It is known to form electric machines with rotors and/or stators which are in each case formed by stacks of soft-magnetic laminations. Such stacks of soft-magnetic laminations must be laboriously assembled and electrically insulated, in order that no eddy currents or voltage flashovers occur during the operation of the electric motors.

### SUMMARY

The teachings of the present disclosure include an electric machine with a rotor and/or stator with a stack of soft-magnetic laminations in which an electrical insulation of the soft-magnetic laminations can be realized at low cost and with little effort.

Moreover, the electric machine can also be manufactured by novel manufacturing processes for producing the soft-magnetic laminations. For example, some embodiments include an electric machine with a stator (80) and/or a rotor with a stack (10) of soft-magnetic laminations (20), which are close to one another on flat sides (30, 50) of the laminations, the laminations being electrically insulated from one another by means of in each case at least one of the flat sides (50) that is formed with metal oxide (55).

In some embodiments, at least one flat side (50) on which two adjacent laminations are close to one another is formed with metal oxide (55).

In some embodiments, every two adjacent laminations (20) of the stack (10) on at least one flat side (50) formed with metal oxide (55) lie against one another.

In some embodiments, all of the laminations (20) of the stack (10) have at least one flat side (50), preferably two flat sides, which is/are formed with metal oxide (55).

In some embodiments, the stack (10) has peripheral laminations and all of the laminations of the stack, excluding the peripheral laminations of the stack, have at least one flat side (50), preferably two flat sides, which is/are formed with metal oxide (55).

In some embodiments, laminations (20) with at least one flat side (50) formed with metal oxide (55) are sintered parts and/or stencil-printed parts.

In some embodiments, the laminations (20) each have a first (30) and a second flat side (50), the laminations (20) tapering from the first (30) to the second flat side (50) and the first flat sides (30) of the laminations (20) of the stack (10) facing in the same direction.

In some embodiments, the metal oxide (55) is formed by a sintering skin.

In some embodiments, the laminations (20) are electrically insulated from one another by means of an additional insulating layer.

As another example, some embodiments include an installation and/or a vehicle with an electric machine (110) as described herein.

### BRIEF DESCRIPTION OF THE DRAWINGS

The teachings of the present disclosure are explained in more detail below on the basis of an exemplary embodiment that is represented in the drawing, in which:

FIG. 1 shows a stack of soft-magnetic laminations of a stator of an electric machine incorporating teachings of the present disclosure schematically in cross section; and

FIG. 2 shows an industrial installation with a drive with the electric machine incorporating teachings of the present disclosure with a stator with the stack of soft-magnetic laminations according to FIG. 1 schematically in a basic diagram.

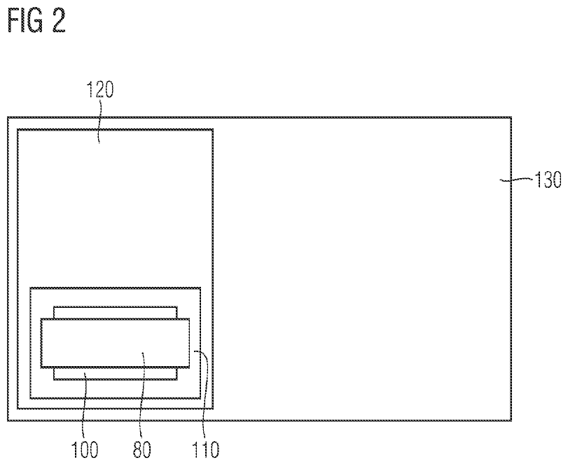

### DETAILED DESCRIPTION

The electric machines described herein have a stator and/or a rotor with a stack of soft-magnetic laminations. The laminations of the stack of the electric machine incorporating teachings of the present disclosure are close to one another on flat sides of the laminations, the laminations being electrically insulated from one another by means of in each case at least one of the flat sides that is formed with metal oxide.

In some embodiments, the laminations may be formed with metal oxide, e.g. superficially, and so there is no need for a separate additional insulating layer. In some embodiments, the flat side formed with metal oxide is formed with metal oxide over its surface area, e.g. over its full surface area. The expression “electrically insulated from one another by means of a flat side formed with metal oxide” means that some or all of the laminations would not be electrically insulated from one another if the metal oxide were not present and/or if the metal oxide were replaced by a remaining metal of the laminations. In other words, forming the at least one flat side of the laminations with metal oxide as provided by the invention brings about for the first time the electrical insulation present of the laminations of the stack in the event of such current and/or voltage values for which the electric machine is designed to operate.

Even superficial layers of metal oxide with a thickness of more than 5 nanometers, e.g. with a thickness of more than 5 micrometers, can have comparatively high insulating effects. In this way, the laminations can consequently be advantageously formed at the same time compactly and with a reliable electrical insulation.

“Laminations” in the sense of the present disclosure may also be intended to mean printed and/or sintered parts. In the context of the present disclosure, the term “laminations” could also be replaced by the expression “material layer or material layer structure”, the material layer or the material layer structure preferably being a flat part. In other words, the term “lamination” does not necessarily imply in the present case that the “lamination” is produced by means of rolling. Such a “lamination” may be formed by means of sintering, e.g. by printing and subsequent sintering.

In some embodiments, in the case of the electric machine, at least one flat side on which two adjacent laminations are close to one another is formed with metal oxide. In some embodiments, all of the flat sides on which adjacent laminations are close to one another are formed with metal oxide. In this way, there is no need for additional insulating layers between the laminations in the electrical machine, and so the stator and/or rotor can be formed particularly compactly in the case of the electric machine.

In some embodiments, every two adjacent laminations of the stack on at least one flat side formed with metal oxide lie against one another. Every two laminations adjacent to one another can be electrically insulated from one another by means of at least one flat side formed with metal oxide.

In some embodiments, all of the laminations of the stack have at least one flat side, e.g. two flat sides, which is/are formed with metal oxide. All of the laminations of the stack can be formed in the same way, and so all of the laminations of the stack can be manufactured by means of the same manufacturing process, e.g. in parallel, i.e. at the same time.

In some embodiments, the stack has peripheral laminations and all of the laminations of the stack, optionally excluding one or two of the peripheral laminations of the stack, have at least one flat side, e.g. two flat sides, which is/are formed with metal oxide.

In this way, all of the laminations or all of the laminations apart from one or two of the peripheral laminations can be formed in an identical way. Consequently, almost all of the laminations can be manufactured in an identical way. Consequently, manufacturing of the electrical machine can be performed without deviations or required manual interventions.

In some embodiments, laminations with at least one flat side formed with metal oxide are sintered parts and/or stencil-printed parts. The laminations, including the flat side formed with metal oxide, may be expediently manufactured by means of stencil printing and sintering. As sintered parts, the laminations of the stack of the electric machine can be provided with a sintering skin, which is formed by the metal oxide. In this way, the laminations can be formed particularly easily with flat sides with metal oxide.

In some embodiments, the laminations are also stencil-printed parts, in which the laminations are printed by means of a printing paste formed by metal powder and are subsequently sintered. In this way, a geometrical shape of the laminations can be realized particularly easily by means of stencil printing, and so there is no need for subtractive machining steps for manufacturing the electric machine. In some embodiments, the laminations have no induced mechanical stresses as a result of shaping processes, such as in particular rolling or stamping processes, for which reason the soft-magnetic properties of the soft-magnetic laminations can be retained unimpaired.

In some embodiments, the metal oxide is formed by a sintering skin. A sintering skin can be easily formed with isotopically oriented, i.e. not textured, grain sizes with diameters expediently between 10 and 500 micrometers, the sintering skin preferably having an average roughness of between 0.2 micrometers and 5 micrometers. Especially in the case of a surface formed with a sintering skin, very flat grain surfaces without specific peaks protruding from the grain and, on the surface, sunken grain boundaries with rounded flanks can be realized. A sintering skin can expediently be formed variously in the region of a surface facing a carrier substrate during printing, to provide a flat side facing away from the carrier substrate during printing or an edge area continuing from the carrier substrate. Consequently, the laminations can be formed with flat sides with different colors and/or reflections and/or surface structures. In this way, flat sides of the laminations can be easily distinguished, and so an arrangement of the laminations into a stack can be accomplished particularly easily and preferably can be automated.

In some embodiments, the laminations each have a first and a second flat side, the laminations tapering from the first to the second flat side and the first flat sides of the laminations of the stack facing in the same direction. In this way, the flat sides of the laminations can be distinguished from one another, and so, in particular in the case of laminations in which just one of two flat sides is formed with metal oxide, the side formed with metal oxide can be easily identified on the basis of the geometrical shape.

In some embodiments, the laminations are electrically insulated from one another by means of an additional insulating layer. In this development, an electrical insulation of the laminations from one another is not achieved by the metal oxide alone, but instead the additional insulating layer together with the metal oxide ensures the electrical insulation of the laminations from one another.

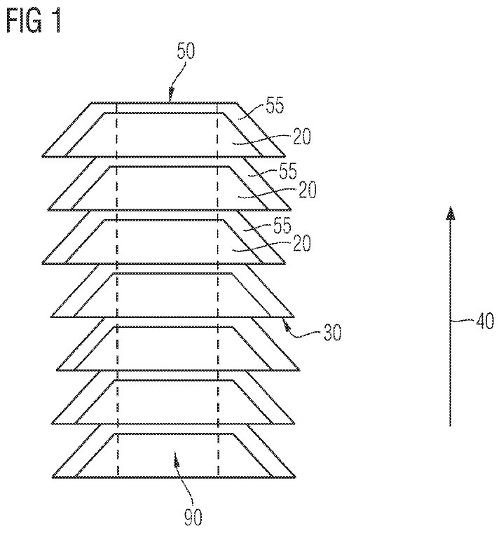

The stack 10 shown in FIG. 1 is formed by soft-magnetic laminations 20 and forms a stator of an electric machine incorporating teachings of the present disclosure in the form of an electric motor. The soft-magnetic laminations 20 of the stack 10 are manufactured by means of screen and stencil printing of a metal paste of soft-magnetic metal, for example pure iron, and in each case have externally the form of a truncated cone with a circular base area 30. In addition, the externally frustoconical soft-magnetic laminations 20 are provided with a central lead-through, in which a rotor of the electric machine according to the invention is provided. The soft-magnetic and externally frustoconical laminations 20 in each case taper in a stacking direction 40 from the base area 30 to an end face 50, which has a smaller outer diameter in comparison with the base area 30 and is parallel to the base area 30. The end faces 50 of the soft-magnetic laminations 20 are formed by a metal oxide layer, here an iron oxide layer 55, of the soft-magnetic laminations 20. In the exemplary embodiment shown, the iron oxide layer 55 is caused by the manufacturing process and is not removed after manufacture, but is left on the soft-magnetic laminations 20 before the soft-magnetic laminations 20 are joined together to form a stack.

The frustoconical form and the iron oxide layer 55 of the soft-magnetic laminations 20 are realized by means of the soft-magnetic laminations 20 being manufactured by screen and stencil printing: the soft-magnetic laminations 20 are printed by means of a stencil with an annular hole onto a substrate as circular-cylindrical green blanks with an inner circular-cylindrical lead-through. The substrate is in each case formed with such a high surface roughness that, at its bearing surface on the substrate that forms the later base area 30 of the later soft-magnetic lamination 20, the green blank cannot follow a sintering shrinkage occurring during subsequent sintering of the green blank. The green blank is subsequently sintered. Consequently, the green blank shrinks to a greater extent away from the bearing surface than at the bearing surface, at which the sintering shrinkage even disappears completely on account of the surface roughness. As a result of the locally different sintering shrinkage, an end face of the green blank that forms the later end face 50 of the soft-magnetic lamination 20 is reduced in its diameter as compared with the bearing surface, and so, during the sintering, the green blank adopts an external frustoconical form (internally, the originally cylindrical lead-through likewise adopts a frustoconical form).

At the end face 50 of the soft-magnetic lamination 20, the iron oxide layer 55 takes the form of a so-called as-fired sintering skin. As a result of the sintering of the green blank on the substrate and as a result of the chosen process conditions, the as-fired sintering skin only forms on the surface of the soft-magnetic laminations 20 that is facing away from the substrate. In this way, the end face 50 of the soft-magnetic laminations 20 is in each case formed by the iron oxide layer 55. Correspondingly, after the sintering, the soft-magnetic laminations 20 can be arranged oriented in the same way with their end face 50, and consequently with their iron oxide layer 55, and so respectively adjacent soft-magnetic laminations 20 lie against one another at an iron oxide layer 55.

After the sintering, the sintered soft-magnetic lamination 20 is detached from the substrate and connected to further soft-magnetic laminations 20 manufactured in the same way to form the stack 10. As already mentioned above, the soft-magnetic laminations 20 are in this case connected to one another in such a way that the base areas 30 of the soft-magnetic laminations 20 in each case face in the same direction (here opposite to the stacking direction 40). The end faces 50 of the soft-magnetic laminations 20 of the stack 10 correspondingly face in the stacking direction 40. The laminations 20 in this case lie with their base areas 30 and end faces 50 against one another.

In some embodiments, the soft-magnetic laminations 20 may also be formed with a different geometrical shape, for instance as mathematical cylinders with an annular base area, either one end face or both end faces facing away from one another and the lateral surfaces being formed with metal oxide, for example iron oxide. The forming of the end faces and lateral surfaces with iron oxide can be achieved for example by means of a corresponding adaptation of the parameters of the sintering process and also by means of a suitable sintering substrate.

In the exemplary embodiment shown, additional insulating layers in addition to the iron oxide layers 55 are not provided between the soft-magnetic laminations 20. In some embodiments, additional insulating layers may be provided between the soft-magnetic laminations 20, which however are dimensioned such that these additional insulating layers could not alone electrically insulate the soft-magnetic laminations 20 from one another during the operation of the electric machine described in more detail below if either the iron oxide layer 55 of the soft-magnetic laminations 20 were not present or if this iron oxide layer 55 were replaced by pure iron.

The stack 10 of soft-magnetic laminations 20 is held in a stack mount (not explicitly shown). The stack mount is electrically insulated from the stack 10 by means of an insulation in the form of an insulating paper (not explicitly shown). In some embodiments, the frustoconical form may already be provided during the printing of the green blanks of the soft-magnetic laminations 20, and so a sintering as described above encourages the formation of the frustoconical form, but does not cause it on its own. In some embodiments, the external frustoconical form may also be predetermined exclusively by a 3D printing of the green blank, and so there is no need for a surface roughness of the substrate as described above.

The stack 10 forms with the insulating paper and the stack mount a stator 80 of an electric machine 100 incorporating teachings of the present disclosure. For this purpose, the lead-throughs of the laminations 20 form in the stack 10 a central lead-through 90, leading in the stacking direction 40. In the exemplary embodiment shown, the lead-through is in each case provided during the printing of the soft-magnetic laminations 20, by the laminations 20 being printed as circular rings. In some embodiments, the lead-through 90 may also be subsequently provided subtractively, for example by means of milling.

For forming an electric machine 110 as described herein, a rotor 100, which in principle can be manufactured in the same way as the stator 80, with the exception of the lead-through 90 and also the stack mount and the insulating paper, which are not needed for a rotor 100, is introduced into the lead-through of the stator 80. For forming an electric machine 110, the stator 80 is provided in a way known per se (not explicitly shown in the drawing) with coils and an electrical feed for the coils.

In the exemplary embodiment shown, the electric machine 110 is an electric motor and part of a drive 120 of an industrial installation 130, here a conveyor belt installation. In some embodiments, the electric machine is an electric motor and part of a drive of an autonomous warehouse vehicle or an electric generator of an energy converter device of an energy generating installation, for example a wind turbine.

What is claimed is:

1. An electric machine comprising:
a stator and/or a rotor with a stack of soft-magnetic laminations;
wherein each lamination is close to an adjacent lamination on respective flat sides of the laminations;
the laminations are electrically insulated from one another by a metal oxide formed on at least one of the flat sides.

2. The electric machine as claimed in claim 1, wherein at least one flat side on each of two adjacent laminations includes a metal oxide.

3. The electric machine as claimed in claim 1, wherein the respective at least one flat side of every two adjacent laminations in the stack lie against one another.

4. The electric machine as claimed in claim 1, in which all of the laminations of the stack have a metal oxide on at least one flat side.

5. The electric machine as claimed in claim 1, wherein:
the stack includes peripheral laminations; and
all of the laminations of the stack except the peripheral laminations have a metal oxide formed on at least one flat side.

6. The electric machine as claimed in claim 1, wherein each lamination comprises sintered parts and/or stencil-printed parts.

7. The electric machine as claimed in claim 1, wherein:
each of the laminations has a first flat side and a second flat side;
the laminations tape from the first flat side to the second flat side; and
the first flat sides of each of the laminations in the stack face in a shared direction.

8. The electric machine as claimed in claim 1, wherein the metal oxide is formed by a sintering skin.

9. The electric machine as claimed in claim 1, wherein each of the laminations is electrically insulated from an adjacent lamination by an additional insulating layer.

10. (canceled)
